(19) United States
(12) Patent Application Publication
(10) Pub. No.: US 2019/0176048 A1
(43) Pub. Date: Jun. 13, 2019

(54) WATER TOY WITH ILLUMINATED WATER STREAM

(71) Applicant: SLIS, Inc., Darien, IL (US)

(72) Inventor: Jiadong Ma, Darien, IL (US)

(21) Appl. No.: 15/836,119

(22) Filed: Dec. 8, 2017

(51) Int. Cl. A63H 29/14; A63H 33/22; F21V 33/00

(52) U.S. Cl. CPC A63H 29/14; F21Y 2115/10; F21V 33/008; A63H 33/22

(57) ABSTRACT

A water apparatus attachable to a water source may include a nozzle and one or more light sources approximate the circumference of the nozzle, such that the one or more light sources project light into a water stream projected from the nozzle.

### FIELD OF THE DISCLOSURE

This disclosure is generally directed to water apparatuses, including water toys, attachments for water toys, attachments for hoses, and the like.

### BACKGROUND OF RELATED ART

Water toys, including water toys that can project a stream of water, are generally known. Such water toys are generally configured to be held by one or both of a user's hands and generally propel a stream of water responsive to actuation of a trigger, pump, or other mechanism on the toy.

### SUMMARY

An embodiment of an apparatus may include a housing having a proximal end and a distal end and defining a central axis that extends from the proximal end to the distal end. The housing may be configured to be coupled to a fluid source. The apparatus may further include a fluid nozzle disposed on or in the housing, the fluid nozzle arranged to project a stream of fluid from the fluid source when coupled with the fluid source. The apparatus may further include a power source disposed within the housing and a light source disposed on or in the housing, the light source positioned radially outward from the nozzle with respect to the central axis of the housing and arranged to project light into the stream of fluid when the light source is electrically connected, directly or indirectly, with the power source.

In an embodiment of the apparatus, the fluid nozzle may be disposed proximate the distal end of the housing, and the light source may be disposed proximate the distal end of the housing.

In an embodiment, the apparatus may further comprise a fluid compartment coupled with the housing, wherein the fluid source comprises the fluid compartment.

In an embodiment, the housing defines a passageway, and the fluid compartment extends through the passageway.

In an embodiment, the power source comprises a battery disposed within the housing.

In an embodiment, the housing may be comprised of plastic.

In an embodiment, the apparatus may further comprise a plurality of light sources, the plurality of light sources comprising the light source. In an embodiment, the plurality of light sources may be disposed around an outer periphery of the nozzle.

In an embodiment, the apparatus may further comprise a fluid compartment coupled with the housing and comprising the fluid source, a proximal handle portion, and a distal handle portion, wherein at least the distal handle portion is defined by the housing, and wherein the proximal handle portion is arranged such that actuation of the proximal handle portion causes the stream of fluid to be projected through the fluid nozzle. In an embodiment, the apparatus may further comprise a switch, electrically coupled to the power source, and configured such that actuation of the switch selectively electrically couples the plurality of light sources with the power source. In an embodiment, the switch may be disposed on an exterior of the distal handle portion. In an embodiment, the apparatus may further comprise a cylindrical body defining the fluid compartment, and a plunger coupled with the proximal handle portion and arranged to extend through the cylindrical body to cause the stream of fluid to be projected through the fluid nozzle. In an embodiment, the cylindrical body may extend into the housing.

In an embodiment, the housing may comprise a distal cap through which the nozzle extends, wherein the distal cap fluidly isolates the light sources from an exterior of the apparatus. In an embodiment, the distal cap may comprise a translucent or transparent portion through which the plurality of light sources disposed about the fluid nozzle project light. In an embodiment, the housing may further comprise a main portion, wherein the distal cap is separable from the main portion of the housing, and the apparatus may further comprise a gasket disposed between the distal cap and the housing main portion. In an embodiment, the distal cap and the housing main portion may comprise respective and complementary threaded portions.

In an embodiment, the nozzle defines a nozzle axis, wherein the nozzle axis is coincident with the central axis of the housing.

In an embodiment, the apparatus may further comprise a plurality of light sources, the plurality of light sources comprising the light source, wherein the nozzle defines a nozzle axis, and wherein the plurality of light sources are each disposed radially outward from the nozzle with respect to both the nozzle axis and the central axis of the body. In an embodiment, the plurality of light sources may be equidistant to the nozzle axis.

### BRIEF DESCRIPTION OF THE DRAWINGS

FIG. 1 is a perspective view of an example embodiment of a water toy, in a first, closed configuration.

FIGS. 2 and 3 are side views of the water toy of FIG. 1, in a closed configuration.

FIG. 4 is a distal end view of the water toy of FIG. 1.

FIG. 5 is a side view of the water toy of FIG. 1, in a second, partially-open configuration.

FIG. 6 is a partially-exploded view of the water toy of FIG. 1.

FIG. 7 is an enlarged end view of a distal handle portion of the water toy of FIG. 1, with an end cap removed for clarity of illustration.

FIG. 8 is an enlarged exploded view of a distal handle portion of the water toy of FIG. 1.

### DETAILED DESCRIPTION

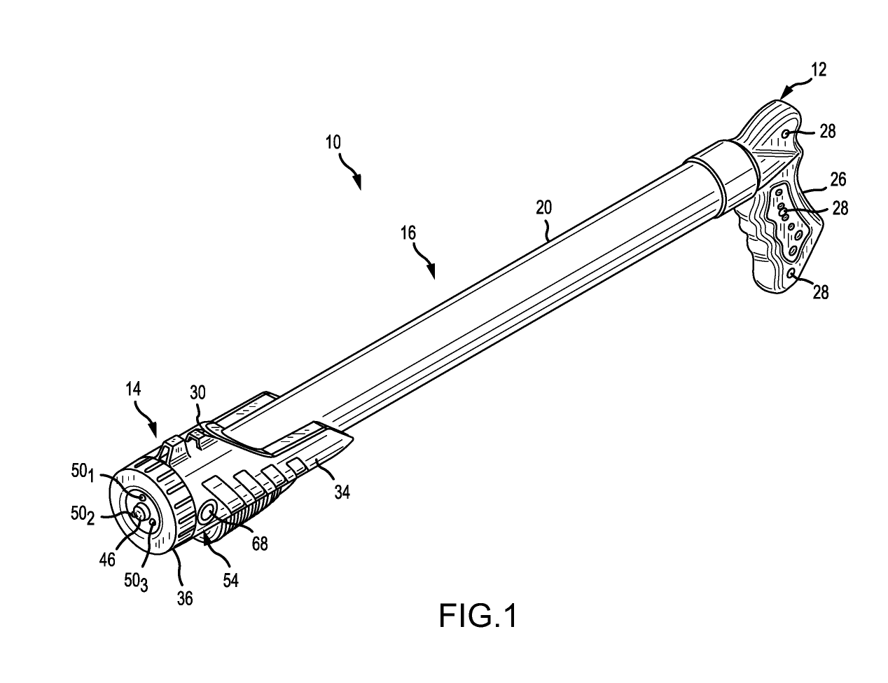

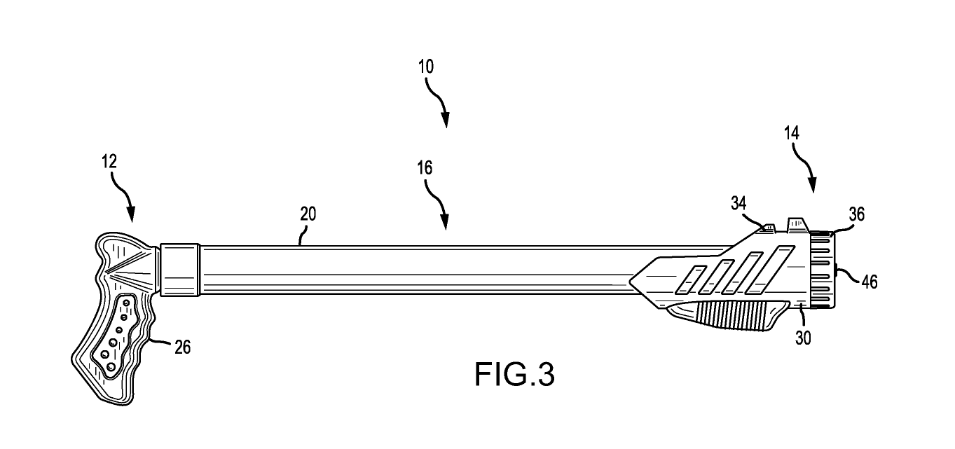

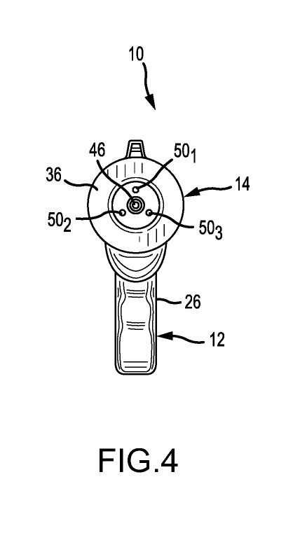

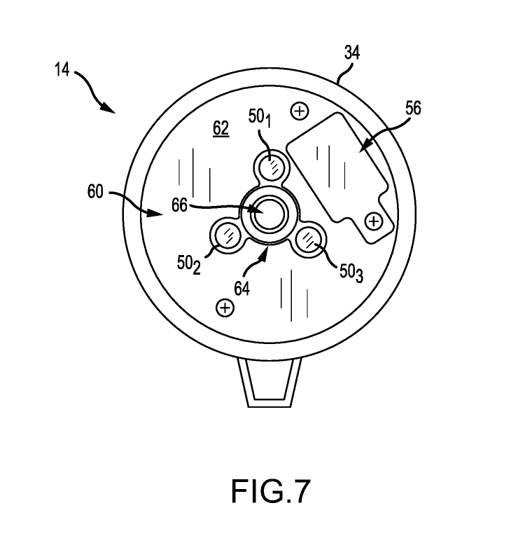

Referring to the figures, in which like reference numerals refer to the same or similar features in the various views, FIGS. 1-8 are various views of an example embodiment of a water toy 10, or portions thereof. The water toy 10 may advantageously produce an illuminated stream of water, thus improving upon known water toys.

The water toy 10 may include a first handle portion 12, a second handle portion 14, and a body 16. The body 16 may be generally cylindrical and may define a fluid compartment 18 configured to receive, store, and expel fluid, such as water. In an embodiment, the body 16 of the water toy 10 may include a hollow tube 20 defining a central lumen 22, with the central lumen 22 serving as fluid compartment 18.

The first handle portion 12 may be disposed at and coupled to the proximal end (i.e. end typically closest to the user's body when in operation) of the body 16. The first proximal handle portion 12 may be mechanically coupled with a plunger 24 that is disposed within the body 16 of the water toy 10 and movable relative to the body 16. In an embodiment, the first handle portion 12 may be rigidly coupled with the plunger 24, such that the plunger 24 is moved out of the body 16 of the water toy (i.e., in a proximal direction) by a user drawing back the first handle portion 12 and the plunger 24 is moved into the body 16 of the water toy 10 (i.e., in a distal direction) by a user pushing the first handle portion 12. In other embodiments, the plunger 24 may be movable responsive to actuation of some other aspect of the first handle portion 12, such as a trigger mechanism, for example.

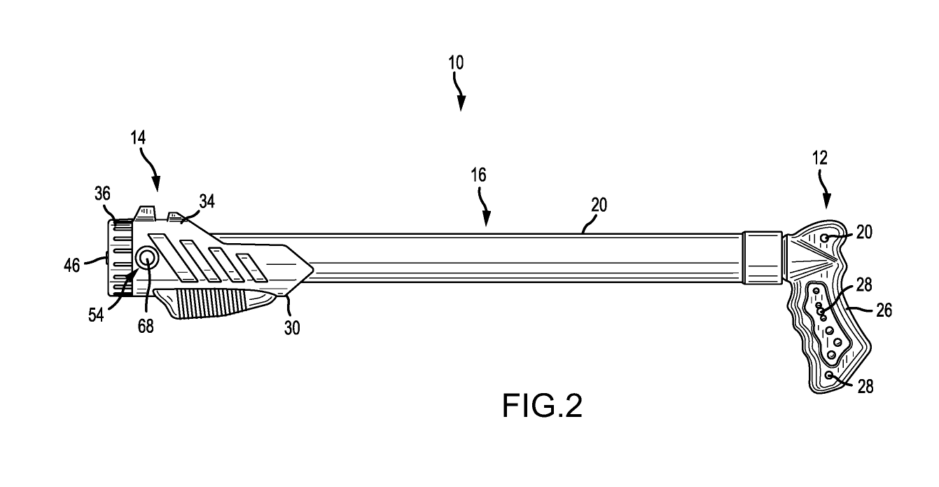

The first handle portion 12 may comprise a plastic material, in an embodiment. The first handle portion may include a grip portion 26 configured to be held by a user's hand, which may include one or more receiving formations for a user's fingers, in an embodiment. The first handle portion may be constructed from multiple pieces, in an embodiment, which may be attached to each other by fasteners such as screws 28 (shown in phantom in FIGS. 1 and 2 to differentiate the fasteners from bump formations on the first handle portion).

The second handle portion 14 may be disposed at and coupled to a distal end (i.e., end furthest from the user's body when in typical operation) of the water toy body 16. The second handle portion 14 may include a housing 30 defining a passageway 32. In an embodiment, the passageway 32 may be substantially cylindrical. In an embodiment, at least a portion of the main body 16 of the water toy 10 may extend into the passageway 32. Accordingly, in an embodiment, at least a portion of the fluid compartment 18 may extend into the passageway 32. In an embodiment, the second handle portion 14 may be separable from and attachable to the body 16.

The housing 30 may include a main portion 34 and a distal cap 36. The distal cap 36 may be separable from the main portion 34 of the housing 30. The distal cap 36 may include a threaded portion 38, and the main housing portion 34 may include a threaded portion 40, and the threads of the threaded portions 38, 40 of the distal cap 36 and the main housing portion 34 may be complementary such that the distal cap 36 may be coupled to the main housing portion 34 by screwing the distal cap 36 on to the main housing portion 34. The water toy 10 may further include a gasket 42 disposed at the interface of the main housing portion 34 and the distal cap 36. The distal cap 36 may further include a transparent or translucent portion 44. In an embodiment, the transparent or translucent portion 44 may comprise a transparent or translucent disk.

The water toy 10 may further include a nozzle 46 disposed at the distal end of the water toy 10. In the embodiment illustrated, the nozzle 46 is disposed in the transparent or translucent portion 44 of the distal cap 36 such that the transparent or translucent portion 44 of the distal cap 36 radially surrounds the nozzle 46. The nozzle 46 may be fluidly coupled with the fluid compartment 18 and may be arranged to project a stream of fluid in a distal direction. In an embodiment, the plunger 24, fluid compartment 18, and nozzle 46 may be collectively arranged such that a stream of fluid may be projected from the nozzle 46 responsive to movement of the plunger 24 in a distal direction.

The water toy 10 may further include a plurality of light sources 50₁, 50₂, 50₃ (which may be referred to collectively as the light sources 50 or individually as a light source 50), a power source 52, and a switch 54 that is coupled to the power source 52 such that actuation of the switch 54 selectively electrically couples the plurality of light sources 50 to the power source 52. In an embodiment, the plurality of light sources 50, the power source 52, and the switch 54 may all be disposed in or on the main housing portion 34. In an embodiment, the power source 52 may be one or more batteries. In an embodiment, the power source 52 may be stored in a compartment 56, such as a battery compartment, in the main housing portion 34.

The light sources 50 may be disposed about the nozzle 46, in an embodiment. For example, the light sources 50 may be disposed around an outer periphery of the nozzle 46. The light sources may be arranged so that, when activated, the light sources 50 project light in a distal direction into a stream of fluid that is projected from the nozzle 46. The stream of fluid may conduct the light and the illuminated stream of fluid may have a pleasant appearance. Each of the light sources 50 may be or may include a light-emitting diode (LED), in an embodiment. In the embodiment illustrated, three light sources 50₁, 50₂, 50₃ are provided. In other embodiments, one light source 50, two light sources 50, or some other number of light sources 50 may be provided.

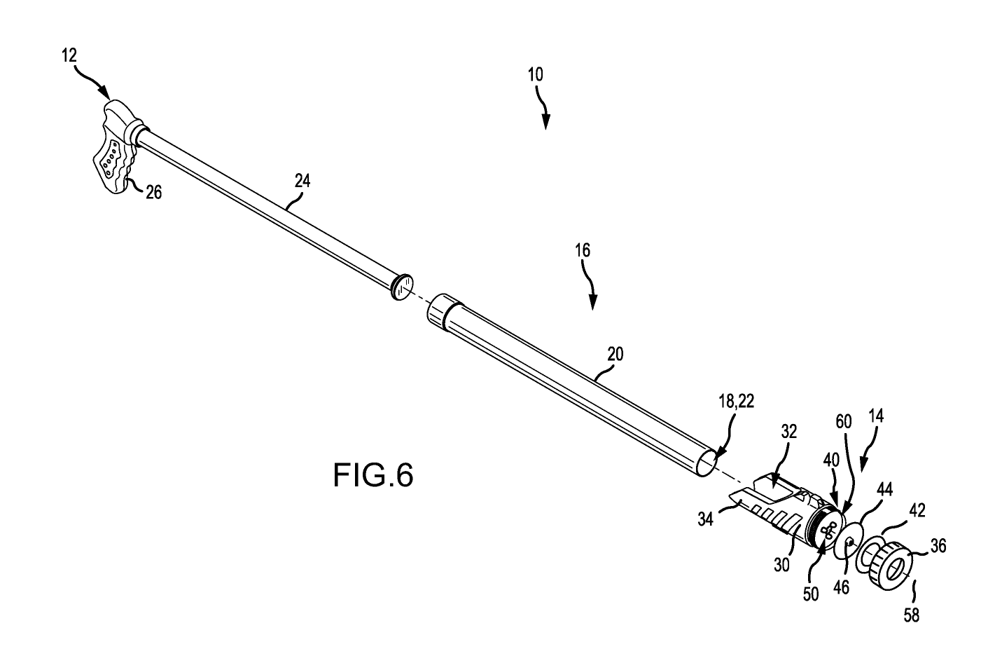

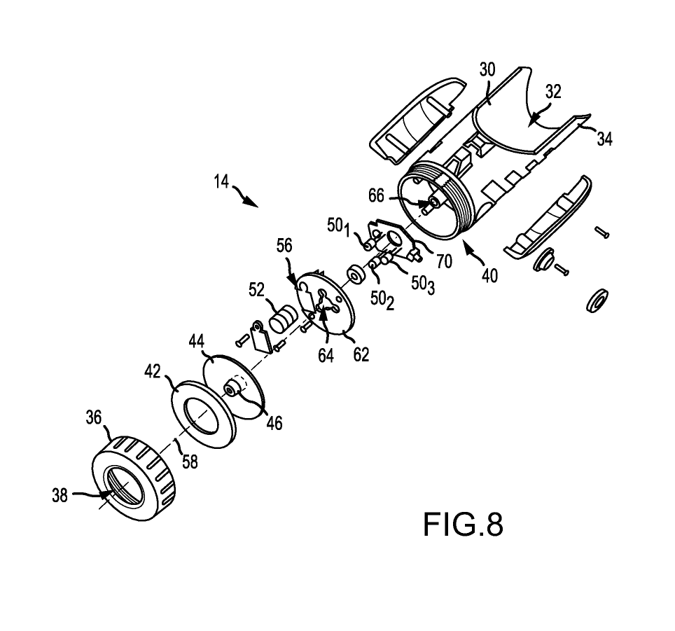

In an embodiment, the nozzle 46 of the toy 10 may define an axis 58 (see FIGS. 6, 8) along which the nozzle 46 initially directs fluid as the fluid is ejected from the nozzle. In the example embodiment illustrated in the figures, the nozzle axis 58 is coincident with an axis that extends through the second handle portion 14 and the body 16 of the toy 10. That is, the nozzle axis 58 may also serve as a central axis of the housing 30 (which extends from a proximal end of the housing 30 to a distal end of the housing 30) of the second handle portion 14 and/or a central axis of the body 16, in embodiments. In other embodiments, the nozzle axis 58 may be offset or angled from a central axis of the housing 30 and/or an axis of the body 16. Further, although the housing 30 is illustrated herein as generally cylindrical (i.e., having a circular cross-section), the housing 30 need not have a circular cross-section and need not have radial symmetry to define a central axis. Similarly, the nozzle 46 need not be circular and need not have radial symmetry to define a nozzle axis 58.

The light sources 50 may be substantially equidistant to the nozzle axis 58 or the nozzle 46 (that is, each of the light sources 50 may be the same distance from the nozzle axis or the nozzle 46), in an embodiment. The light sources 50 may be substantially equidistant to each other, in an embodiment. Each of the light sources 50 may be disposed five centimeters or less from the nozzle 46 or from the nozzle axis 58, in an embodiment. Each of the light sources 50 may be disposed three centimeters or less from the nozzle 46 or from the nozzle axis 58, in an embodiment. Each of the light sources 50 may be disposed between 0.5 centimeters and 1.5 centimeters from the nozzle 46 or from the nozzle axis 58, in an embodiment.

The light sources 50 may project into a cavity 60 collectively defined by the housing main portion 34 and the distal cap 36. The cavity 60 may be bound on one end by a housing plate 62 and on another end by the transparent or translucent portion 44 of the distal cap 36. The housing plate 62 may include one or more apertures 64 through which a fluid lumen 66 and the light sources 50 extend. The fluid lumen 66 may provide a fluid connection between the fluid compartment 18 and the nozzle 46.

When the distal cap 36 is attached to the housing main body 34 and the light sources 50 are activated, the light sources 50 may project light through the transparent or translucent portion 44 of the distal cap 36. In addition, in an embodiment, the distal cap 36, housing main body 34, and gasket 42 may substantially isolate the light sources 50 and the power source 52 from fluids and the exterior of the second handle portion.

In an embodiment, the switch 54 may include a button 68 disposed on an exterior surface of the second handle portion 14. The switch 54 may further include a control circuit 70 that receives mechanical input from the button 68 and controls the electrical coupling of the plurality of light sources 50 to the power source 52 in response. In some embodiments, the control circuit 70 may be configured such that power is only provided to the light sources 50 while the button 68 is depressed (e.g., by the finger of a user). In other embodiments, the control circuit 70 may be configured such that power is provided to the light sources 50 upon a first press of the button 68, and power to the light sources 50 may then be disconnected with a second press of the button 68. Other power control strategies may alternatively be implemented, such as flashing, timer-based disconnection, and the like.

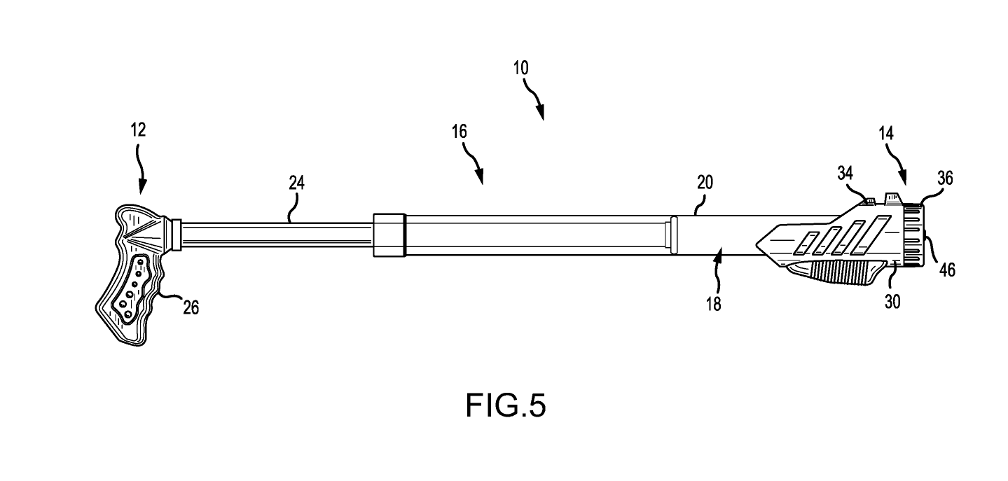

In operation, a user may fill the fluid compartment 18 by submerging the distal end of the toy 10 in fluid and drawing the proximal handle portion 12 in a proximal direction to alter the toy 10 from a first, closed configuration (shown in FIGS. 1-3) to a second, open or partially-open configuration (where FIG. 5 illustrates a partially-open configuration). The user may then project a stream of illuminated water or other fluid from the water toy 10 by moving the proximal handle portion 12 (and, therefore, plunger 24) in a distal direction (to project the water) while holding the button 68 (to project light into the water stream). In embodiments of the water toy 10 having a different mechanical arrangement or components, different mechanical processes or means may be used in conjunction with light sources 50 disposed around a fluid nozzle 46 to project a stream of illuminated fluid, as disclosed herein.

The above description has referred to an embodiment in which the nozzle 46, light sources 50, power source 52, and switch 54 are provided as part of a handle portion 14 for a water toy 10. In other embodiments, the handle portion 14, or some other housing or construction including the light sources 50, power source 52, and/or switch 54 may be provided as a separable component that is configured to be coupled with a water toy body. In still other embodiments, the handle portion 14, or some other housing or construction including the light sources 50, power source 52, and/or switch 54, may be provided as a separable attachment that is configured to be coupled with a hose or other water source. It will be appreciated that, in such alternate embodiments, mechanical modifications may be made from what is explicitly illustrated and described in this disclosure to create such an attachment (e.g., modifications to dimensions and component layout, addition of fastening surfaces, such as a threaded surface for coupling with the end of a hose, and the like) so as to properly couple the light sources 50, power source 52, and switch 54 with the separate water source, such as a hose, and provide an illuminated stream of water from the water source as disclosed herein. For example, an embodiment of an attachment including a housing 30, light sources 50, power source 52, and switch 54 may screw on to the end of a hose. In another example, an embodiment of an attachment including a housing 30, light sources 50, power source 52, and switch 54 may clamp on to the end of a separate water toy. Other examples are possible and contemplated.

While this disclosure has described certain embodiments, it will be understood that the claims are not intended to be limited to these embodiments. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

1. An apparatus comprising:
a housing having a proximal end and a distal end and defining a central axis that extends from the proximal end to the distal end, the housing configured to be coupled to a fluid source;
a fluid nozzle disposed on or in the housing, the fluid nozzle arranged to project a stream of fluid from the fluid source when coupled with the fluid source;
a power source disposed within the housing; and
a light source disposed on or in the housing, the light source positioned radially outward from the nozzle with respect to the central axis of the housing and arranged to project light in a distal direction into the stream of fluid when the light source is electrically coupled with the power source;
wherein the fluid nozzle is disposed proximate the distal end of the housing; and
wherein the light source is disposed proximate the distal end of the housing.

2. (canceled)

3. The apparatus of claim 1, further comprising a fluid compartment coupled with the housing, wherein the fluid source comprises the fluid compartment.

4. The apparatus of claim 3, wherein the housing defines a passageway, and the fluid compartment extends through the passageway.

5. The apparatus of claim 1, wherein the power source comprises a battery disposed within the housing.

6. The apparatus of claim 1, wherein the housing comprises plastic.

7. The apparatus of claim 1 where the light source further comprises:
a plurality of light sources.

8. The apparatus of claim 7, wherein the plurality of light sources are disposed around an outer periphery of the nozzle.

9. The apparatus of claim 1, further comprising:
a fluid compartment coupled with the housing and comprising the fluid source;
a proximal handle portion; and
a distal handle portion;
wherein at least the distal handle portion is defined by the housing;
wherein the proximal handle portion is arranged such that actuation of the proximal handle portion causes the stream of fluid to be projected through the fluid nozzle.

10. The apparatus of claim 9, further comprising:
a switch, electrically coupled to the power source, and configured such that actuation of the switch selectively electrically couples the plurality of light sources with the power source.

11. The apparatus of claim 10, wherein the switch is disposed on an exterior of the distal handle portion.

12. The apparatus of claim 9, further comprising:
a cylindrical body defining the fluid compartment; and
a plunger coupled with the proximal handle portion and arranged to extend through the cylindrical body to cause the stream of fluid to be projected through the fluid nozzle.

13. The apparatus of claim 12, wherein the cylindrical body extends into the housing.

14. The apparatus of claim 1, wherein the housing comprises:
a distal cap through which the nozzle extends, wherein the distal cap fluidly isolates the light sources from an exterior of the apparatus.

15. The apparatus of claim 12, wherein the distal cap comprises:
a translucent or transparent portion through which the plurality of light sources disposed about the fluid nozzle project light.

16. The apparatus of claim 13, wherein the housing further comprises a main portion, wherein the distal cap is separable from the main portion of the housing, the apparatus further comprising:
a gasket disposed between the distal cap and the housing main portion.

17. The apparatus of claim 14, wherein the distal cap and the housing main portion comprise respective and complementary threaded portions.

18. The apparatus of claim 1, wherein the nozzle defines a nozzle axis, wherein the nozzle axis is coincident with the central axis of the housing.

19. The apparatus of claim 1, further comprising:
a plurality of light sources, the plurality of light sources comprising the light source;
wherein the nozzle defines a nozzle axis;
wherein the plurality of light sources are each disposed radially outward from the nozzle with respect to both the nozzle axis and the central axis of the housing.

20. The apparatus of claim 19, wherein the plurality of light sources are equidistant to the nozzle axis.
